(19) United States
(12) Patent Application Publication
(10) Pub. No.: US 2016/0103310 A1
(43) Pub. Date: Apr. 14, 2016

(54) TWO-PHOTON EXCITATED FLUORESCENCE MICROSCOPE

(71) Applicant: UNIVERSITA' DEGLI STUDI DI PAVIA, Pavia (IT)

(72) Inventors: Alessandra TOMASELLI, Pavia (IT); Luca TARTARA, Pavia (IT); Elton HASANI, Pavia (IT)

(73) Assignee: UNIVERSITA' DEGLI STUDI DI PAVIA, Pavia (IT)

(21) Appl. No.: 14/786,020

(22) PCT Filed: Mar. 28, 2013
(86) PCT No.: PCT/EP2013/056681

§ 371 Date: Oct. 21, 2015

(51) Int. Cl. G02B 21/16; G02B 27/09; G02B 21/02; G02F 1/35

(52) U.S. Cl. CPC G02B 21/16; G02F 1/3526; G02B 27/0966; G02B 21/025

(57) ABSTRACT

A two-photon excited fluorescence microscope including a laser source configured to emit a light beam and an optical arrangement configured to receive the light beam from the laser source. The optical arrangement is configured to shape the light beam so that, at an output of the microscope, the light beam is substantially collimated in a first transverse direction perpendicular to the propagation direction of the light beam at the microscope output and is focused in a second transverse direction perpendicular to the first transverse direction and to the propagation direction, thereby forming a line parallel to the first transverse direction.

### TECHNICAL FIELD

The present invention relates to the field of optical devices. In particular, the present invention relates to a two-photon excited fluorescence microscope.

### BACKGROUND ART

Two-photon absorption (in brief, TPA) is a known non-linear optical process whereby two photons are simultaneously absorbed by a molecule, thereby exciting the molecule from an initial state to a higher energy state. The excitation results in a subsequent emission of a fluorescence photon having higher energy than either of the two excitatory photons.

Two-photon excited fluorescence (TPEF) microscopy is an imaging technique which uses the above TPA and consequent fluorescence for providing images of samples, especially living tissue samples. Since TPA is a non-linear optical process, its magnitude is proportional to the second power of the light intensity, so that TPA mainly occurs on the light focus. Then, TPEF microscopy inherently has high resolution, since out-of-focus contributions are negligible. This is advantageous over microscopy based on single-photon absorption, which is a linear optical process and which accordingly generates non-negligible out-of-focus contributions that shall be filtered by means of a spatial filter.

A TPEF microscope typically comprises a pulsed laser suitable for providing a pulsed light beam and an objective suitable for focusing the pulsed light beam into a focal point within the sample. The TPEF microscope also typically comprises a scanning system suitable for moving the focal point within the sample. The TPEF microscope further comprises a detecting system suitable for collecting the fluorescence emitted by the area excited by the focused light beam within the sample and reconstructing therefrom an image of the sample.

Efforts have been made for providing TPEF microscopes capable of generating real-time images of samples. Typically, the expression “real time imaging” is understood as the capability of providing a sequence of images of the sample at an image rate equal to or higher than about 30 images per second, which roughly corresponds to the frame rate of a video signal.

The maximum image rate that can be achieved by a TPEF microscope is typically limited by the intrinsic speed of the fluorescence phenomenon, the speed of the scanning system and the speed of the detection system. The latter factor is particularly limiting, since a detection system typically allows reconstructing images acquired point by point at an image rate of at most few images per second.

It is known increasing the image rate by using a multifocal technique, namely generating more than one focal point in the sample at a time. In particular, the known line-scanning technique provides for focussing the light beam emitted by the pulsed laser in a continuous line, typically by means of a cylindrical lens. This allows simultaneously acquiring multiple points of the sample image, thereby reducing the scanning time (a 2D image of the sample may be obtained by moving the line along a single direction) and the time for reconstructing the image.

However, experimental works have shown that the performance of a TPEF microscope are severely degraded when line-scanning technique implemented by a cylindrical lens is used.

Jeffrey B. Guild et al. “Line scanning microscopy with two-photon fluorescence excitation”, W-Pos. 192, Biophysical Journal Vol. 68, issue 2, P2 page A290 February 1995 discloses that, unlike the point focused TPEF, the total line focused TPEF increases logarithmically with sample thickness. This additional background fluorescence reaches twice the focal volume signal when focusing into a thickness of about 100 microns (1.3 NA).

G. J. Brakenhoff et al. “Real-time two-photon confocal microscopy using a femtosecond, amplified Ti:sapphire system”, Journal of Microscopy, Vol. 181, Pt 3, March 1996, pp. 253-259 describes a two-photon microscope wherein a line illumination pattern was created by a cylindrical lens. The sectioning power of the microscope was measured without and with a confocal line aperture spatial filter. A worsening of the sectioning capability was observed relative to point focused TPEF (5 microns vs 1 micron), when no confocal line aperture spatial filter is used. However, a substantial improvement in the sectioning capability with the line aperture in place was observed.

### SUMMARY OF THE INVENTION

The inventors have realized that the worsening in the sectioning capabilities of the TPEF microscopes described by Jeffrey B. Guild et al. and G. J. Brakenhoff et al. is due to the fact that the cylindrical lens introduces an aberration in the light beam emitted by the pulsed laser. In particular, the inventors have realized that the cylindrical lens focusses the light beam not in a single line, but in two distinct lines having a certain reciprocal distance along the propagation direction of the light beam.

This is schematically depicted in FIG. 11, which shows a 3D rendering of a light beam obtained by a numerical simulation performed by the inventors. The inventors have simulated the effect of a cylindrical lens onto a Gaussian light beam. FIG. 11 shows the light beam in proximity of the focal plane of the cylindrical lens. Along the propagation direction z, the light beam is focused in a first expected line Le parallel to a first transverse direction x perpendicular to z and also in a second spurious line Ls parallel to a second transverse direction y perpendicular to z and x. The Applicant has performed several simulations showing that the spurious line Ls may either precede or follow the expected line Le along the propagation direction z, depending on whether the light beam at the input of the objective diverges or converges. Assuming that the distance between the two lines Le and Ls along the direction z is shorter than the sample thickness, both the lines Le and Ls may fall within the sample thickness. Fluorescence may be accordingly excited in two distinct areas located at different depths in the sample.

The graph of FIG. 12a shows the area in the xy plane (measured in m²) of the light beam shown in FIG. 11 vs. displacement relative to the focal plane of the cylindrical lens (ranging from −100 μm to 100 μm). It can be seen that the beam area has an approximately parabolic profile having an expected minimum Me corresponding to the expected line Le and a spurious minimum Ms corresponding to the spurious line Ls.

The graph of FIG. 12b shows the irradiance (namely, the optical power per unit area measured in W/m²) of the light beam shown in FIG. 11 vs. displacement relative to the focal plane of the cylindrical lens (ranging from −100 μm to 100 μm). It can be seen that the irradiance exhibits an expected peak Pe corresponding to the expected line Le and a spurious peak Ps corresponding to the spurious line Ls. The spurious peak Ps is of the same order of magnitude as the expected peak Pe, meaning that the spurious fluorescence excited by the light beam focused at the spurious line Ls is of the same order of magnitude as the expected fluorescence excited by the light beam at the expected line Le. Besides, the light beam exhibits a not-negligible irradiance in the whole sample thickness comprised between the peaks Pe and Ps, which might give raise to further spurious fluorescence. The spurious fluorescence is then an undesired non-negligible out-of-focus contribution, which impairs the resolution (in particular, the axial resolution, namely the resolution along the propagation direction of the light beam) and the Point Spread Function (namely, the impulse response to a point source) of the TPEF microscope.

In view of the above, the inventors have tackled the problem of providing a two-photon excited fluorescence (TPEF) microscope which overcomes the aforesaid drawback.

In particular, the inventors have tackled the problem of providing a two-photon excited fluorescence (TPEF) microscope implementing the above mentioned line-scanning technique, in which out-of-focus contributions are negligible, so that the microscope has an axial resolution and a Point Spread Function comparable to those of point-focussed TPEF microscopes.

In the present description and in the claims, the expression “substantially confocal”, when referred to a couple of lenses, will indicate that the lenses are arranged at a reciprocal distance which is substantially equal to the sum of their focal lengths, i.e. equal to the sum of their focal lengths subject to a tolerance of 10 mm.

Further, in the present description and in the claims, the expression “substantially collimated beam” will indicate a light beam having a divergence lower than 1 mrad.

According to an aspect, the present invention provides a two-photon excited fluorescence microscope comprising:
a laser source suitable for emitting a light beam; and
an optical arrangement suitable for receiving the light beam from the laser source and for shaping the light beam so that, at an output of the microscope, the light beam is substantially collimated in a first transverse direction perpendicular to a propagation direction of the light beam at the output of the microscope- and is focused in a second transverse direction perpendicular to the first transverse direction and to the propagation direction, thereby forming a line parallel to the first transverse direction.

Preferably, the optical arrangement comprises a cylindrical lens and an objective.

According to an embodiment, the cylindrical lens and the objective are substantially confocal. This allows focusing the light beam in a line by means of a very compact arrangement, since only two elements (namely, the cylindrical lens and the objective) are needed.

According to other embodiments, the optical arrangement further comprises a spherical lens interposed between the cylindrical lens and the objective.

Preferably, the spherical lens and the objective are substantially confocal.

According to an embodiment, the cylindrical lens has a cylindrical surface with an axis contained in a plane parallel to the first transverse direction and the propagation direction. In other words, the axis of the cylindrical lens and the line lie in a same plane.

Optionally, a distance between the cylindrical lens between the spherical lens is tunable for tuning a distance between the objective and the line. Alternatively, a focal length of the cylindrical lens is tunable for tuning a distance between the objective and the line. Both options allow implementing a very efficient axial scanning of a sample.

Preferably, the microscope further comprises a scanning system configured to translate the line along the second transverse direction, the scanning system being positioned at a back-focal plane of the cylindrical lens. This advantageously maximizes the scanning angle.

According to other embodiments, the optical arrangement comprises a further spherical lens.

Preferably, the cylindrical lens and the further spherical lens are substantially confocal and the further spherical lens and the spherical lens are substantially confocal.

Preferably, the cylindrical lens has a cylindrical surface with an axis contained in a plane parallel to the second transverse direction and the propagation direction. In other words, the axis of the cylindrical lens and the line lie on perpendicular planes.

Optionally, the further spherical lens is interposed between the cylindrical lens and the spherical lens. Alternatively, the cylindrical lens is interposed between the further spherical lens and the spherical lens.

This latter option provides a more compact arrangement. Moreover, preferably, the microscope further comprises a scanning system configured to translate the line along the second transverse direction, the scanning system being positioned at a back-focal plane of the further spherical lens. This advantageously maximizes the scanning angle.

### BRIEF DESCRIPTION OF THE DRAWINGS

The present invention will become clearer from the following detailed description, given by way of example and not of limitation, to be read with reference to the accompanying drawings, wherein:

FIG. 1 schematically shows a TPEF microscope, according to a first embodiment of the present invention;

FIGS. 2a and 2b are side views of the light beam propagating through the microscope of FIG. 1 in the xz plane and yz plane, respectively;

FIG. 3 schematically shows a TPEF microscope, according to a second embodiment of the present invention;

FIGS. 4a and 4b are side views of the light beam propagating through the microscope of FIG. 3 in the xz plane and yz plane, respectively;

FIG. 5 schematically shows a TPEF microscope, according to an advantageous variant of the second embodiment;

FIGS. 6a and 6b are side views of the light beam propagating through the microscope of FIG. 5 in the xz plane and yz plane, respectively;

FIG. 7 schematically shows a TPEF microscope, according to a third embodiment of the present invention;

FIGS. 8a and 8b are side views of the light beam propagating through the microscope of FIG. 7 in the xz plane and yz plane, respectively;

FIG. 9 is a 3D rendering of the light beam emitted by the microscope of FIG. 1;

FIGS. 10a-10f are graphs of simulation results relating to the microscope of FIG. 1;

FIG. 11 (already described) is a 3D rendering of a light beam focused by a cylindrical lens; and

FIGS. 12a and 12b (already described) are graphs of simulation results relating to the light beam of FIG. 11.

### DETAILED DESCRIPTION OF PREFERRED EMBODIMENTS OF THE INVENTION

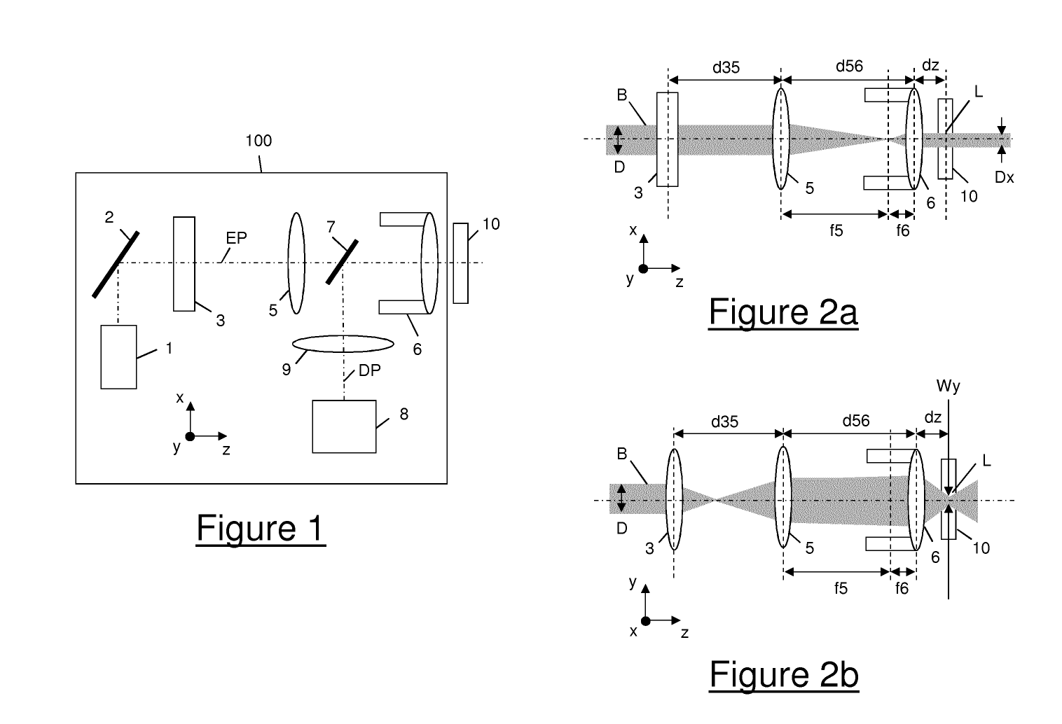

FIG. 1 shows a two-photon excited fluorescence (TPEF) microscope 100 according to an embodiment of the present invention. In FIG. 1 and in other Figures, a Cartesian coordinate system comprising three orthogonal axes or directions x, y and z is schematically depicted. The Figures are not in scale.

The microscope 100 preferably comprises a pulsed laser 1 (in particular, a mode-locked laser) suitable for emitting a sequence of ultrashort light pulses, namely light pulses of a duration of the order of magnitude of 100 femtoseconds. The repetition rate of the light pulses emitted by the pulsed laser 1 preferably ranges from 80 MHz to 200 MHz. The average optical power emitted by the pulsed laser 1 preferably ranges from 50 mW to 700 mW. The emission wavelength of the pulsed laser 1 lies in the red and near-infrared region. In particular, the pulsed laser 1 preferably is a Ti:sapphire laser having emission wavelength tuneable from 700 nm to 1100 nm.

The microscope 100 also preferably comprises a scanning system 2. The scanning system 2 preferably is a galvanometric scanner comprising a mirror and a galvanometer suitable for rotating the mirror so as to translate the light beam emitted by the microscope 100 along the direction y, as it will be described in detail herein after. Alternatively, the scanning system 2 may be an acousto-optic scanner, a resonant scanner or a polygonal mirror scanner.

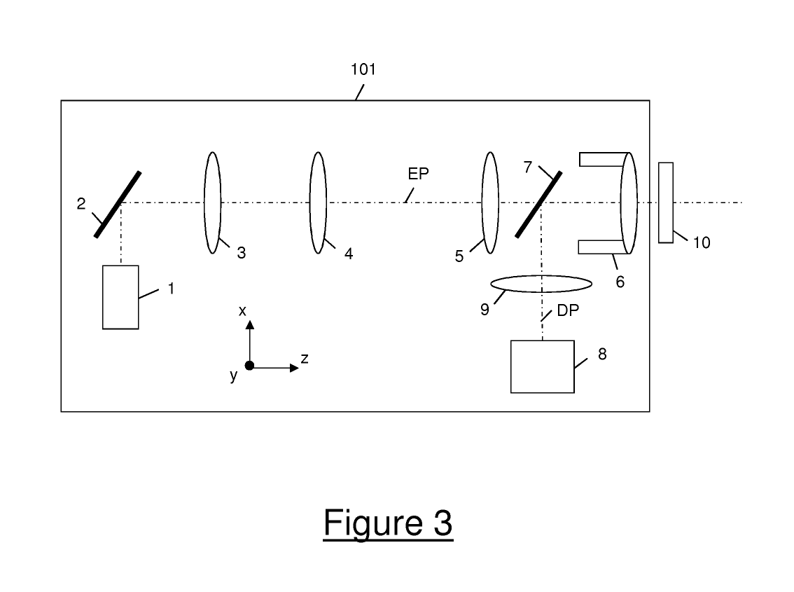

The microscope 100 also preferably comprises a cylindrical lens 3. As known, a cylindrical lens is a lens which focuses incident light into a continuous line. A cylindrical lens typically comprises at least one curved face, which basically is a section of a cylinder. The cylindrical lens 3 may have one curved surface (piano-convex lens) or two curved surfaces (biconvex lens). The cylindrical lens 3 is preferably a plano-convex lens. The cylindrical lens 3 is arranged so that its curved surface is a section of a cylinder having axis parallel to the direction x, as visible in FIG. 2b. The cylindrical lens 3 preferably has a focal length f3 comprised between 20 mm and 80 mm, more preferably comprised between 40 mm and 60 mm, even more preferably equal to about 50 mm. The size of the cylindrical lens 3 in the x and y directions preferably is of about 1 inch (2.54 cm).

The microscope 100 also preferably comprises a spherical thin lens 5. The lens 5 is preferably a plano-convex spherical lens having a focal length f5. The focal length f5 is preferably longer than the focal length f3 of the cylindrical lens 3. In particular, the focal length f5 preferably ranges from 100 mm to 150 mm, more preferably from 120 mm to 130 mm, even more preferably is equal to about 125 mm. The size of the spherical lens 5 in the x and y directions preferably is of about 1 inch (2.54 cm).

The microscope 100 also preferably comprises an objective 6. The objective 6 comprises a cylinder in turn comprising at least one objective lens. The objective 6 preferably has a focal length f6 much shorter than the focal length f5 of the spherical lens 5. In particular, the focal length f6 of the objective 6 is preferably shorter than 5 mm, more preferably shorter than 3 mm, even more preferably equal to about 1.8 mm.

As shown in FIGS. 2a and 2b, the cylindrical lens 3 and the spherical lens 5 are spaced by a reciprocal distance d35. The distance d35 is equal to f3+f5+Δ, Δ being a real number ranging from −(f3+f5) to +f3. When Δ=0, the cylindrical lens 3 and the spherical lens 5 are confocal.

Further, the spherical lens 5 and the objective 6 are spaced by a reciprocal distance d56. According to the present invention, the distance d56 is chosen so that the spherical lens 5 and the objective 6 are substantially confocal, namely their reciprocal distance d56 is substantially equal to f5+f6. This allows focalizing the light beam B in a single line at the output of the microscope 100, as it will be discussed in detail herein after.

The pulsed laser 1, the scanning system 2, the lenses 3, 5 and the objective 6 define a light emission path EP, whose portion comprised between the cylindrical lens 3 and the objective 6 is preferably straight and parallel to direction z. The direction z will accordingly be termed herein after also “propagation direction”. This is merely exemplary and has been assumed for simplicity. According to other embodiments not shown in the drawings, the microscope 100 may comprise further mirrors between the cylindrical lens 3 and the objective 6, which deflect the light emission path EP from the direction z.

The microscope 100 also preferably comprises a dichroic mirror 7. The dichroic mirror 7 is preferably configured to transmit light originated by the pulsed laser 1 (whose wavelength is e.g. 700 nm to 1000 nm) and to reflect fluorescence emitted by a sample 10 excited by the light originated by the pulsed laser 1 (whose wavelength is typically much shorter than the emission wavelength of the laser 1, e.g. 400-500 nm). The dichroic mirror 7 is preferably arranged between the spherical lens 5 and the objective 6. The dichroic mirror 7 preferably forms and angle of about 45° with the propagation direction z, so as to deflect the fluorescence onto a light detection path DP substantially perpendicular to the propagation direction z. According to embodiments not shown in the drawings, the dichroic mirror 7 may be configured to reflect light originated by the pulsed laser 1 and transmit fluorescence emitted by a sample 10 excited by the light originated by the pulsed laser 1. In such case, the light emission path EP is L-shaped.

The microscope 100 also preferably comprises a photodetector 8 suitable for detecting the fluorescence emitted by the sample 10, collected by the objective 6 and reflected by the dichroic mirror 7. The photodetector 8 preferably comprises a matrix CCD (Charge-Coupled Device) (e.g. Electron Multiplying CCD or Intensified CCD). The photodetector 8 provides an electronic signal indicative of the detected fluorescence, which subsequently allows reconstructing an image of the sample 10.

The microscope 100 also preferably comprises a further lens 9 interposed between the dichroic mirror 7 and the photodetector 8 and suitable for focusing the fluorescence reflected by the dichroic mirror 7 onto the photodetector 8. The microscope 100 may also comprise a filter (not shown in the drawings) interposed between the dichroic mirror 7 and the photodetector 8, for filtering possible scattered light out of the desired bandwidth.

The operation of the microscope 100 will be described in detail herein after.

The pulsed laser 1 preferably emits a light beam B. The light beam B preferably is a Gaussian beam with a diameter D at the output of the pulsed laser 1. The light beam B is preferably substantially collimated (namely it exhibits a very low divergence, e.g. 0.5-0.6 mrad), so that its diameter D is substantially constant as it propagates along the emission path EP towards the cylindrical lens 3.

With reference first to FIG. 2a, in the xz plane the cylindrical lens 3 does not have any focusing effect on the light beam B emitted by the pulsed laser 1. The light beam B then passes through the cylindrical lens 3 and reaches the spherical lens 5 substantially without any modification in the xz plane. In particular, its width along the direction x is still substantially equal to the original beam diameter D. Then, since the spherical lens 5 and the objective 6 are substantially confocal, they basically act as a telescope which shrinks the light beam B in the xz plane, namely at the output of the objective 6 (and therefore of the whole microscope 100) the light beam B is still substantially collimated in the xz plane and has a reduced and substantially constant width Dx<D along the direction x. In particular, the width Dx of the light beam B along the direction x at the output of the microscope 100 is equal to:

Dx=(f6/f5)·D. [1]

It shall be noticed that the width Dx does not depend on any feature of the cylindrical lens 3, in particular it depends neither on its focal length f3 nor its distance d35 from the spherical lens 5.

With reference now to FIG. 2b, in the yz plane the cylindrical lens 3 focuses the light beam B. In particular, since the cylindrical lens 3 and the spherical lens 5 are placed at a reciprocal distance d35=f3+f5+Δ (f5 being larger than f3), they magnify the light beam B in the yz plane, namely at the output of the spherical lens 5 the light beam B has a width larger than D along the direction y. The light beam B may be collimated, divergent or convergent, depending on whether A is zero, negative or positive. The light beam B then propagates up to the objective 6 which, in the yz plane, focuses the light beam B at a distance dz from the objective 6. The distance dz is equal to:

dz=f6−(f6/f5)²·Δ. [2]

The waist Wy of the light beam B (namely, its size along the direction y at a distance dz from the objective 6) is equal to:

Wy=(f3·f6/f5)·div, [3]

where div is the divergence of the light beam B at the input of the cylindrical lens 3.

Hence, the light beam B at the output of the microscope 100 is substantially collimated in the xz plane while is focused in the yz plane, meaning that the light beam B is focused in a single line L lying in the xy plane and parallel to the direction x. The line L has a distance from the objective 6 equal to dz provided by the above equation [2], a length equal to Dx provided by the above equation [1] and a width equal to the beam waist Wy provided by the above equation [3].

The scanning system 2 preferably translates the line L along the direction y so that, at each scanning cycle, a 2D image of a sample section parallel to the xy plane is acquired. By positioning the mirror of the scanning system 2 substantially at the back focal plane of the cylindrical lens 3 (namely, at a distance f3 from the cylindrical lens 3), the scanning angle in the yz plane (namely, the maximum angle by which the beam B may be deflected in the yz plane) is advantageously maximized. The sample 10 may be scanned also in the propagation direction z, by moving the sample 10 or by changing dz (which may be done by changing the focal length f3 of the cylindrical lens 3 or by moving the cylindrical lens 3 along the direction z, as it will be discussed herein after).

Therefore, thanks to the substantially confocal arrangement of the spherical lens 5 and the objective 6, at the output of the microscope 100 the light beam B is substantially collimated in the xz plane, namely its size along the direction x is substantially constant. Since the light beam B does not converge in the xz plane (a substantially collimated beam converging at infinity), no spurious line parallel to the direction y is created or, in other words, the spurious line is moved at infinity. Therefore, no other focal points or lines are generated at the output of the microscope 100 (and, in particular, within the sample 10), except the line L which excites two-photon fluorescence in a single linear area of the sample 10. Since no spurious focal points are generated within the sample 10, the fluorescence generated by such excited linear area is free from out-of-focus contributions and accordingly provides a very clean linear image of the sample 10, without the need of any spatial filter for eliminating undesired background noise. In other words, the axial resolution inherent to TPEF is advantageously preserved in the microscope 100, in spite of the use of a cylindrical lens for implementing a line-scanning technique.

In case the spherical lens 5 and the objective 6 are not exactly confocal (namely, d56 is different from f5+f6), at the output of the objective 6 the light beam B converges also in the xz plane at a distance dz′ from the objective 6 which is equal to dz′=f6+(f6)²/disp where disp is d56−(f5+f6), namely the displacement of the lenses 5 and 6 from the confocal arrangement. In other words, a spurious line is formed parallel to the direction y and placed at a distance dz′ from the objective 6. For avoiding spurious fluorescence in the sample 10, such spurious line shall fall out of the sample thickness 10. Hence, the maximum displacement of the lenses 5 and 6 from confocal arrangement (namely, the tolerance on the distance d56) is found by setting the modulus of the reciprocal distance dz−dz′ between line L and spurious line larger than the thickness of the sample 10. The difference dz−dz′ has a much stronger dependence on disp (namely, on the relative displacement of the lenses 5 and 6) than on A (namely, on the relative displacement of the lenses 3 and 5). Indeed, moving the cylindrical lens 3 from confocal configuration by hundreds of millimeters shifts the line L by at most tens of microns relative to the objective focal plane, thereby allowing a very fine tuning of the position of the line L within the sample 10. On the other hand, assuming an objective focal length f6 of few millimeters, a displacement of the lens 5 from exact confocal configuration with the objective 6 by 10 millimeters brings the spurious line from infinity to a distance of few hundreds of microns from the objective focal plane, which is the order of magnitude of typical sample thicknesses. Hence, for guaranteeing that the spurious line falls out of the sample thickness, the distance d56 of lenses 5 and 6 is subject to a tolerance of 10 millimeters, more preferably of 1 millimeter, even more preferably 100 microns.

The microscope 100 then advantageously may be used for real-time imaging applications (30 frames/second or more, the acquisition time for each frame being of few milliseconds and being substantially independent of the resolution), since it employs line-scanning technique which provides a substantial increase of the image rate, as discussed above. The inventors have indeed carried out several tests where an acquisition rate of 350 frames/second was achieved. On the other hand, in the microscope 100 the line-scanning technique does not bring about any degradation of the TPEF axial resolution, which is advantageously comparable to that of point-focused TPEF microscopes. The inventors have observed that also the Point Spread Function is advantageously comparable to that of point-focused TPEF microscopes. High resolution, real-time imaging is accordingly provided by the microscope 100.

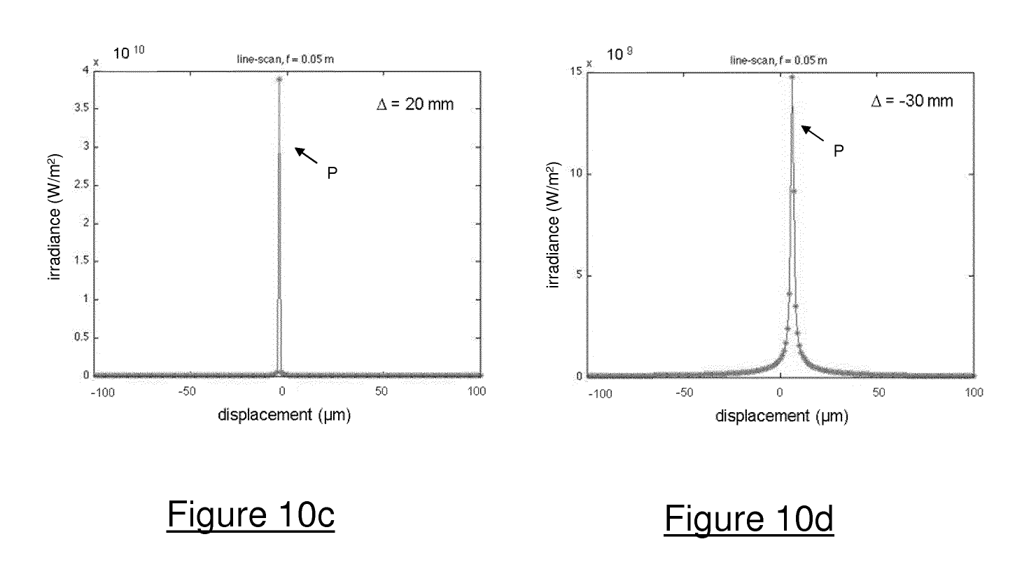

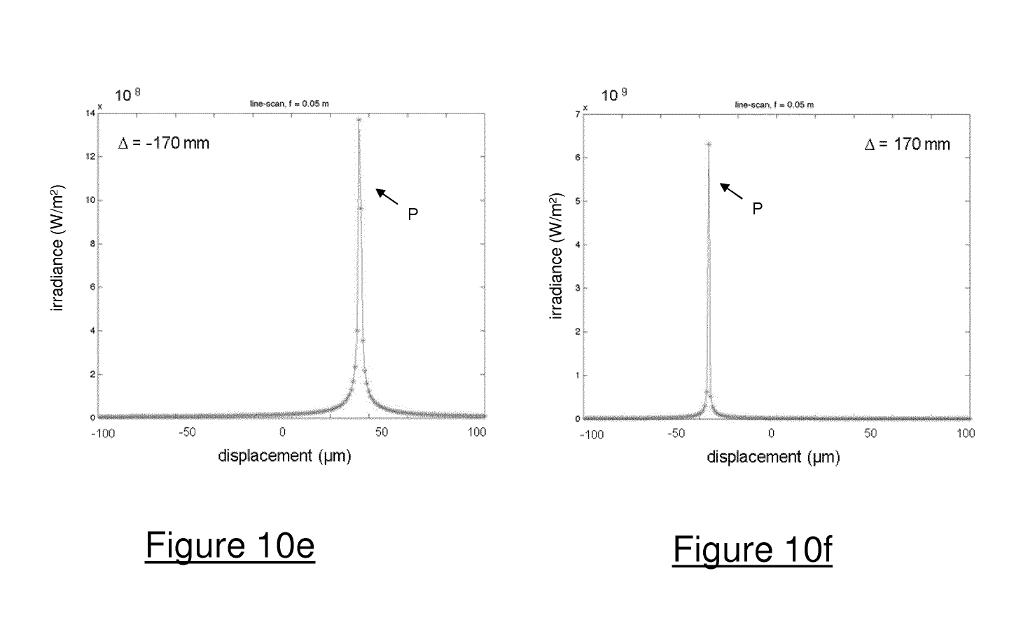

FIGS. 9 and 10a to 10f are results of numerical simulations of the operation of the microscope 100, carried out by the inventors based on the known ray transfer matrix analysis (also known as “ABCD matrix analysis”). The input parameters of the algorithm were wavelength and beam waist of the light beam B at the output of the laser 1 (which allow deriving divergence, bending radius, Rayleigh Range of the light beam B), focal lengths f3, f5, f6 and distances d35, d56. Propagation of the light beam B through a free space (which represents the light path portion comprised between laser 1 and cylindrical lens 3) and then through cylindrical lens 3, spherical lens 5 and objective 6 is then simulated. The values of the input parameters are set forth herein below:
Wavelength=810 nm;
Beam waist=0.5 mm;
Beam diameter D at the input of cylindrical lens 3=3.4 mm;
Focal length f3=50 mm;
Focal length f5=125 mm; and
Focal length f6=1.8 mm.
Distance d35=f3+f5=175 mm;
Distance d56=f5+f6=126.8 mm.

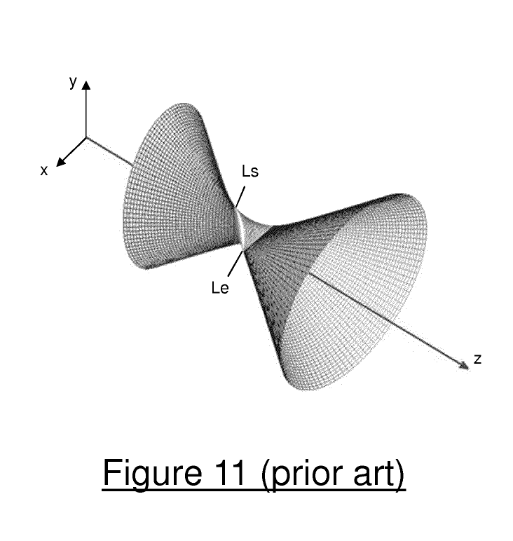

FIG. 9 is a 3D rendering of the light beam B in proximity of the focal plane of the objective 6. It can be seen that, differently from the light beam of the above described FIG. 11, the light beam B is collimated in the xz plane, namely it has a substantially constant width Dx along the direction x. This provides a double advantage. First of all, the light beam B is focused in a single line L parallel to the transverse direction x, while it is not focused in any other line parallel to the transverse direction y. On the other hand, the length of the line L (which, as discussed above, corresponds to the width Dx of the beam B along the transverse direction x) is advantageously fixed and exclusively depends on the ratio f6/f5, while being independent of focal length f3 and position of the cylindrical lens 3 (namely, its distance d35 from the spherical lens 5).

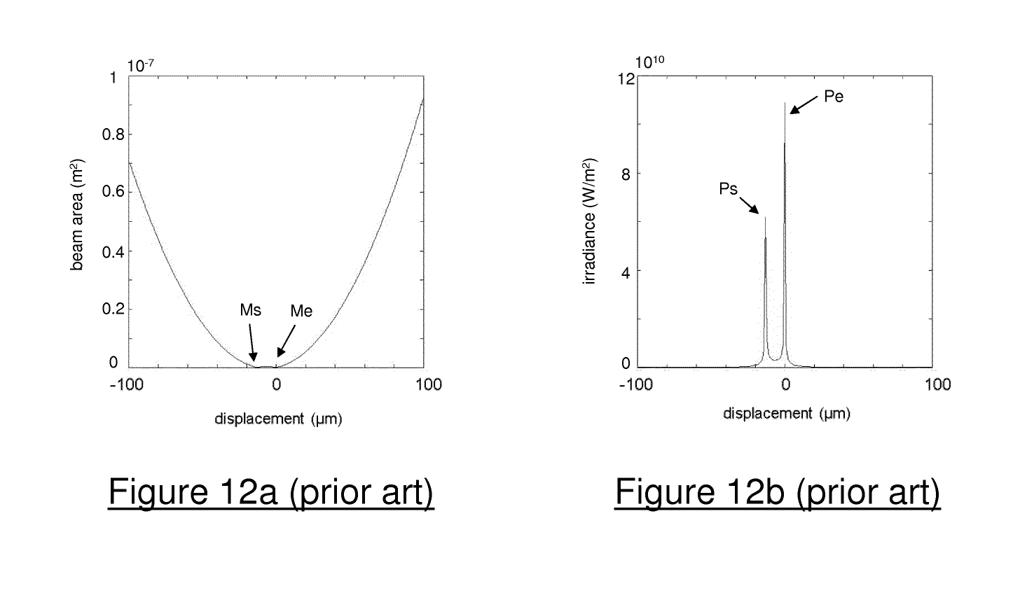

The graph of FIG. 10a shows the area in the xy plane (measured in m²) of the light beam B shown in FIG. 9 vs. displacement relative to the focal plane of the objective 6 (ranging from −100 μm to 100 μm). Differently from the graph of FIG. 12a, the beam area of the light beam B has a single minimum M placed at the focal plane of the objective 6 (namely dz=f6 since Δ=0, consistently with the above equation [2]) corresponding to the line L. No spurious minima are present, since the light beam B is focused only at the line L. Furthermore, it can be seen that the beam area has a roughly linear (and not a parabolic) profile, due to the fact that only its width along the direction y varies, its width Dx along the direction x being substantially constant. This means that, by moving away from the focal line L along the propagation direction z, close to the focal plane the beam area increases much faster for the light beam B, its increase being linear instead of parabolic. Hence, the sample area in which TPEF is excited is narrower in the propagation direction z, meaning that the microscope resolution in the direction z is increased with respect to known line focused TPEF with confocal line aperture and is comparable to known point focused TPEF.

The graph of FIG. 10b shows the irradiance (namely, the optical power per unit area measured in W/m²) of the light beam B shown in FIG. 9 vs. displacement relative to the focal plane of the objective 6 (ranging from −100 μm to 100 μm), assuming an average optical power of 100 mW. Differently from the graph of FIG. 12b, the irradiance of the light beam B exhibits a single peak P placed at the focal plane of the objective 6 (namely dz=f6 since Δ=0, consistently with the above equation [2]), which corresponds to the line L. No spurious peaks are present in the considered range, which is larger than the typical thickness of the sample 10.

The inventors have carried out further simulations, where the reciprocal distance d35 of cylindrical lens 3 and spherical lens 5 was set to different values. FIGS. 10c to 10f are graphs of the irradiance of the light beam B vs. displacement relative to the focal plane of the objective 6 (ranging from −100 μm to 100 μm) with the distance d35 having the following values:
FIG. 10c: d35=f3+f5+20 mm=175 mm+20 mm=195 mm;
FIG. 10d: d35=f3+f5−30 mm=175 mm−30 mm=145 mm;
FIG. 10e: d35=f3+f5−170 mm=175 mm−170 mm=5 mm;
FIG. 10f: d35=f3+f5+170 mm=175 mm+170 mm=345 mm.

It can be seen that the irradiance peak P shifts relative to the focal plane of the objective 6 by an amount depending on the distance d35. If the distance d35 is shorter than f3+f5, the peak P moves away from the objective 6 along the direction z, whereas if the distance d35 is longer than f3+f5, the peak P moves closer to the objective 6 along the direction z (consistently with the above equation [2]). In any case, a single peak P is always formed within the considered range, irrespective of the distance d35 between the cylindrical lens 3 and the spherical lens 5. This is due to the fact that the collimation of the light beam B in the xz plane at the output of the microscope 100 depends on the confocal arrangement of the lenses 5 and 6, while being independent of the distance d35. As explained above, the distance d35 only affects the distance dz. Therefore, according to the first embodiment shown in FIGS. 1, 2a and 2b, the positioning of the cylindrical lens 3 is advantageously not critical, the distance d35 being subject to a very high tolerance.

On the other hand, according to particularly preferred embodiments, since f3 and d35 do not affect the length of the line L (namely Dx) but only its position along the propagation direction z (namely dz), a scanning of the sample 10 along the longitudinal direction z may be carried out by moving the cylindrical lens 3 along the longitudinal axis z, so as to vary the distance d35 or by changing the focal length f3 of the cylindrical lens 3 without changing its position (change of focal length f3 may be implemented by using a SLM (Spatial Light Modulator) instead of the cylindrical lens 3). This allows varying the distance dz between the objective 6 and the line L, thereby providing a longitudinal scanning of the sample 10. This technique for scanning the sample 10 advantageously allows reaching particularly high scanning rates along the z direction (several frames per second).

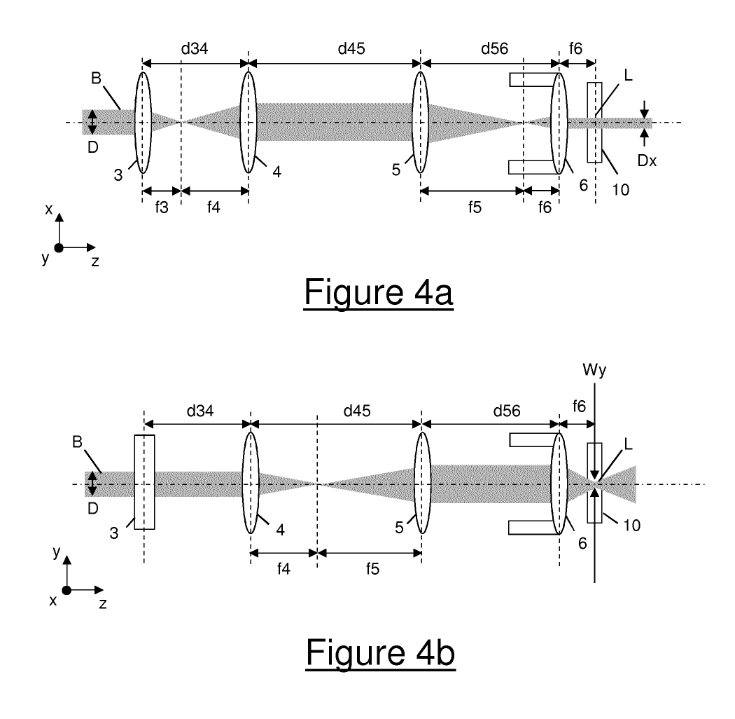

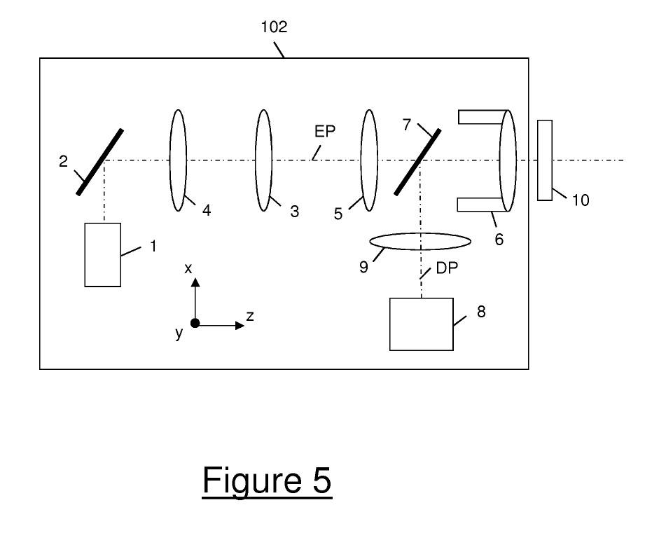

FIGS. 3, 4a and 4b show a microscope 101 according to a second embodiment of the present invention.

The microscope 101 basically differs from the microscope 100 according to the first embodiment in that:
The cylindrical lens 3 is rotated by 90° in the xy plane, namely the cylindrical lens 3 is arranged so that its curved surface is a section of a cylinder having axis parallel to the direction y, as visible in FIGS. 3 and 4a; and
The microscope 101 comprises a further spherical lens 4 interposed between the cylindrical lens 3 and the spherical lens 5.

In particular, the further spherical lens 4 has a focal length f4, which is preferably longer than the focal length f3 of the cylindrical lens 3 and shorter than the focal length f5 of the spherical lens 5. Besides, the further spherical lens 4 is preferably arranged at a distance d34 from the cylindrical lens 3 and at a distance d45 from the spherical lens 5.

The cylindrical lens 3 and the further spherical lens 4 are substantially confocal, namely their reciprocal distance d34 is substantially equal to f3+f4. Further, the further spherical lens 4 and the spherical lens 5 are substantially confocal, namely their reciprocal distance d45 is substantially equal to f4+f5. Similarly to the first embodiment, the spherical lens 5 and the objective 6 are also substantially confocal, namely their reciprocal distance d56 is substantially equal to f5+f6.

The operation of the microscope 101 will be now described in detail herein after, with reference to FIGS. 4a and 4b.

As in the microscope 100, the cylindrical lens 3 receives from the laser 1 a Gaussian light beam B which is substantially collimated and has a diameter D.

With reference first to FIG. 4a, in the xz plane the cylindrical lens 3 focuses the light beam B. In particular, since the cylindrical lens 3 and the further spherical lens 4 are substantially confocal, they basically act as a telescope which magnifies the light beam B in the xz plane, namely at the output of the further spherical lens 4 the light beam B is still substantially collimated in the xz plane and has an increased and substantially constant width along the direction x. The light beam B then reaches the spherical lens 5 substantially without any modification in the xz plane. Then, since also the spherical lens 5 and the objective 6 are substantially confocal, they basically act as a telescope which shrinks the light beam B in the xz plane, namely at the output of the objective 6 (and therefore of the whole microscope 101) the light beam B is still substantially collimated in the xz plane and has a reduced and substantially constant width Dx along the direction x. In particular, the width Dx of the light beam B along the direction x at the output of the microscope 101 is equal to:

Dx=·(f6/f5)·(f4/f3)·D. [4]

With reference now to FIG. 4b, in the yz plane the cylindrical lens 3 does not have any focusing effect on the light beam B emitted by the pulsed laser 1. Indeed, the cylindrical lens 3 does not have any curved surface perpendicular to the yz plane. The light beam B then passes through the cylindrical lens 3 and reaches the further spherical lens 4 substantially without any modification in the yz plane. In particular, its width along the direction y is still substantially equal to the original beam diameter D. Then, since the further spherical lens 4 and the spherical lens 5 are substantially confocal, they basically act as a telescope which magnifies the light beam B in the yz plane, namely at the output of the spherical lens 5 the light beam B is still substantially collimated in the yz plane and has an increased and substantially constant width along the direction y. The light beam B then propagates up to the objective 6 without any significant modification in the yz plane. The objective 6 then focuses the light beam B at a distance dz substantially equal to its focal length f6. The waist Wy of the light beam B (namely, its size along the direction y at a distance dz from the objective 6) is equal to:

Wy=(f4·f6/f5)·div [5]

Hence, the light beam B at the output of the microscope 101 is substantially collimated in the xz plane while is focused in the yz plane, meaning that the light beam B is focused in a single line L lying in the xy plane and parallel to the direction x. The line L is placed at a distance f6 from the objective 6 and has a length equal to Dx provided by the above equation [4] and a width equal to the beam waist Wy provided by the above equation [5]. No spurious lines are formed, since the light beam B at the output of the microscope 101 is substantially collimated in the xz plane, namely its size along the direction x is substantially constant. Since no spurious lines are generated within the sample 10, out-of-focus contributions are negligible and accordingly very clean linear images of the sample 10 are provided.

It shall be noticed that, differently from the first embodiment, in the second embodiment the position of the cylindrical lens 3 affects the shape of the light beam B at the output of the microscope 101 in the plane xz, namely the plane on which—for avoiding spurious lines—the light beam B shall be substantially collimated. Since a certain degree of collimation is needed at least for preventing possible spurious lines from falling within the thickness of the sample 10, the position of the cylindrical lens 3 is subject to much narrower tolerance than in the first embodiment. Besides, differently from the first embodiment, longitudinal scanning of the sample 10 can not be implemented by moving the cylindrical lens 3 or changing its focal length f3.

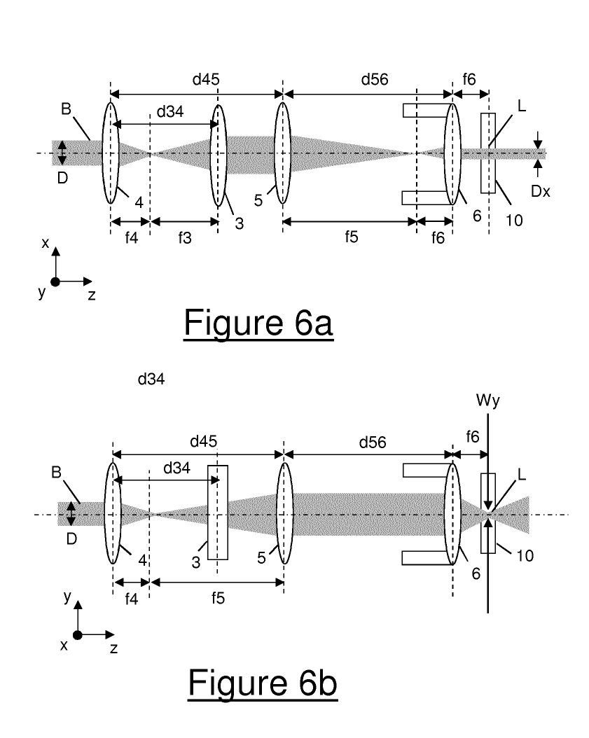

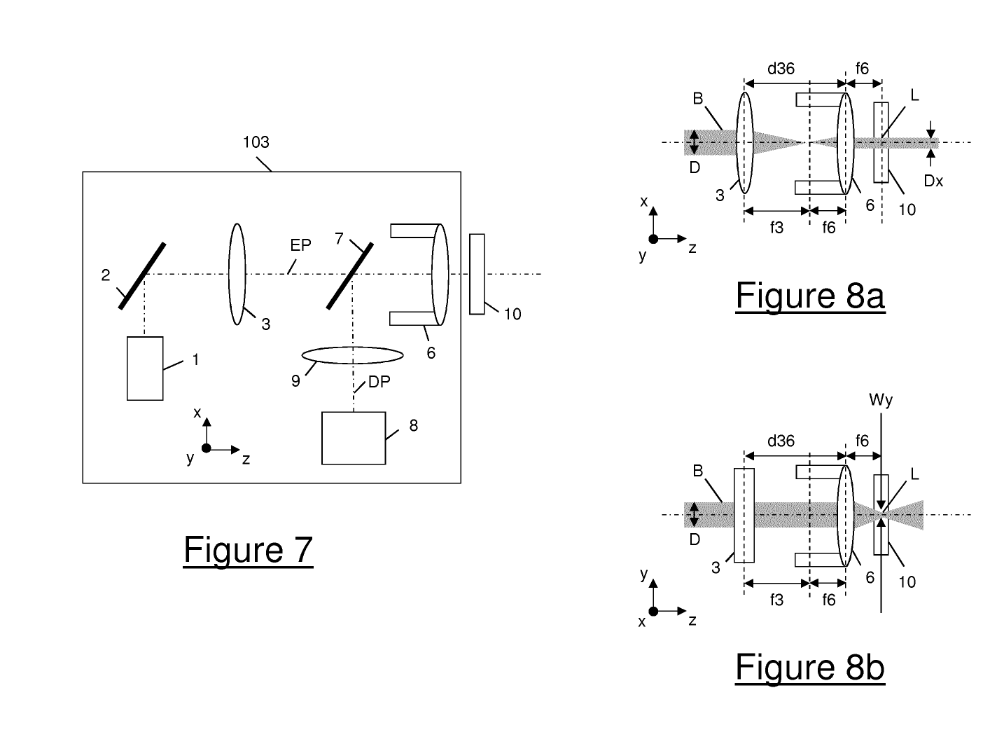

FIGS. 5, 6a and 6b show a microscope 102 according to an advantageous variant of the second embodiment. The microscope 102 basically differs from the microscope 101 according to the second embodiment in that the cylindrical lens 3 is moved between the further spherical lens 4 and the spherical lens 5. The further spherical lens 4 and the spherical lens 5 are still substantially confocal, namely their reciprocal distance d45 is substantially equal to f4+f5. Further, according to such variant, the cylindrical lens 3 and the further spherical lens 4 are substantially confocal, namely their reciprocal distance d34 is substantially equal to f3+f4. According to such variant, the focal length f4 of the further spherical lens 4 is preferably shorter than the focal length f3 of the cylindrical lens.

The operation of the microscope 102 will be now described in detail herein after, with reference to FIGS. 6a and 6b.

Differently from microscope 101, in microscope 102 the Gaussian light beam B emitted by the laser 1 is received first by the further spherical lens 4.

With reference first to FIG. 6a, since the further spherical lens 4 and the cylindrical lens 3 are substantially confocal, they basically act as a telescope which magnifies the light beam B in the xz plane, namely at the output of the cylindrical lens 3 the light beam B is still substantially collimated in the xz plane and has an increased and substantially constant width along the direction x. The light beam B then reaches the spherical lens 5 substantially without any modification in the xz plane. Then, since also the spherical lens 5 and the objective 6 are substantially confocal, they basically act as a telescope which shrinks the light beam B in the xz plane, namely at the output of the objective 6 (and therefore of the whole microscope 102) the light beam B is still substantially collimated in the xz plane and has a reduced and substantially constant width Dx along the direction x. In particular, the width Dx of the light beam B along the direction x at the output of the microscope 102 is equal to:

Dx=·(f6/f5)·(f3/f4)·D. [6]

With reference now to FIG. 6b, since the further spherical lens 4 and the spherical lens 5 are substantially confocal, they basically act as a telescope which magnifies the light beam B in the yz plane, namely at the output of the spherical lens 5 the light beam B is still substantially collimated in the yz plane and has an increased and substantially constant width along the direction y. The cylindrical lens 3 does not have any effect on the light beam B in the yz plane, because it does not have any curved surface perpendicular to the yz plane. Then, the light beam B propagates up to the objective 6 without any significant modification in the yz plane. The objective 6 then focuses the light beam B at a distance dz substantially equal to its focal length f6. The waist Wy of the light beam B (namely, its size along the direction y at a distance dz from the objective 6) is provided by the above equation [5].

Hence, the light beam B at the output of the microscope 102 is substantially collimated in the xz plane while is focused in the yz plane, meaning that the light beam B is focused in a single line L lying in the xy plane and parallel to the direction x. The line L is placed at a distance f6 from the objective 6 and has a length equal to Dx provided by the above equation [6] and a width equal to the beam waist Wy provided by the above equation [5]. No spurious lines are formed, since the light beam B at the output of the microscope 102 is substantially collimated in the xz plane, namely its size along the direction x is substantially constant. Since no spurious lines are generated within the sample 10, out-of-focus contributions are negligible and accordingly very clean linear images of the sample 10 are provided.

It shall be noticed that, similarly to the second embodiment, in this variant the position of the cylindrical lens 3 affects the collimation of the light beam B on the xz plane at the output of the microscope. Therefore, since a certain degree of collimation is needed at least for preventing possible spurious lines from falling within the thickness of the sample 10, also in this variant of the second embodiment the position of the cylindrical lens 3 is subject to much narrower tolerance than in the first embodiment.

Such variant is however advantageous over the microscope 101 in that it is more compact in size. Moreover, according to such variant the mirror of the scanning system 2 may be positioned substantially at the back focal plane of the further spherical lens 4 (namely, at a distance f4 from the further spherical lens 4), so that the scanning angle in the yz plane (namely, the maximum angle by which the beam B may be deflected in the yz plane) is advantageously maximized.

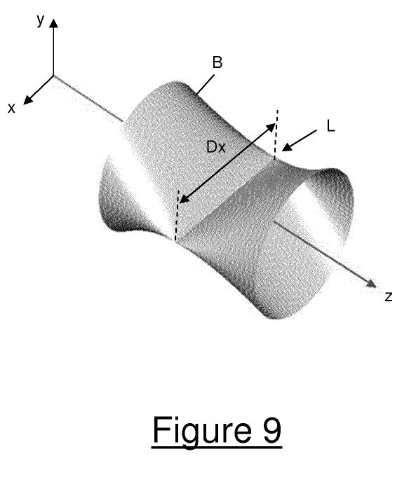

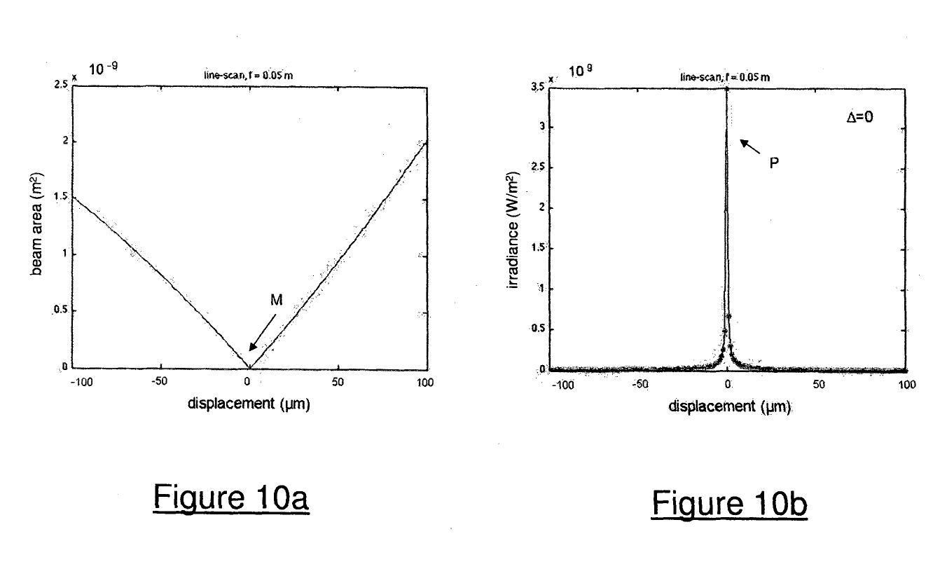

FIGS. 7, 8a and 8b show a microscope 103 according to a third embodiment of the present invention.

In the microscope 103 basically differs from the microscope 100 according to the first embodiment in that:
The cylindrical lens 3 is rotated by 90° in the xy plane, namely the cylindrical lens 3 is arranged so that its curved surface is a section of a cylinder having axis parallel to the direction y, as visible in FIGS. 7 and 8a; and
The microscope 103 does not comprise the spherical lens 5. Namely, on the emission path EP of the light beam B only the cylindrical lens 3 and the objective 6 are provided.

The cylindrical lens 3 and the objective 6 are arranged at a reciprocal distance d36. Preferably, the cylindrical lens 3 and the objective are substantially confocal, namely their reciprocal distance d36 is substantially equal to f3+f6. According to the third embodiment, the focal length f3 of the cylindrical lens 3 is preferably longer than the focal length f6 of the objective 6.

The operation of the microscope 103 will be now described in detail herein after, with reference to FIGS. 8a and 8b.

As in the microscope 100, the cylindrical lens 3 receives from the laser 1 a Gaussian light beam B which is substantially collimated and has a diameter D.

With reference first to FIG. 8a, in the xz plane the cylindrical lens 3 focuses the light beam B. In particular, since the cylindrical lens 3 and the objective 6 are substantially confocal, they basically act as a telescope which shrinks the light beam B in the xz plane, namely at the output of the objective 6 (and therefore of the whole microscope 103) the light beam B is still substantially collimated in the xz plane and has a reduced and substantially constant width Dx<D along the direction x. In particular, the width Dx of the light beam B along the direction x at the output of the microscope 103 is equal to:

Dx=(f6/f3)·D. [7]

With reference now to FIG. 8b, in the yz plane the cylindrical lens 3 does not have any focusing effect on the light beam B emitted by the pulsed laser 1. Indeed, the cylindrical lens 3 does not have any curved surface perpendicular to the yz plane. The light beam B then passes through the cylindrical lens 3 and reaches the objective 6 substantially without any modification in the yz plane. The objective 6 then focuses the light beam B at a distance dz substantially equal to its focal length f6. The waist Wy of the light beam B (namely, its size along the direction y at a distance dz from the objective 6) is equal to:

Wy=f6·div [8]

Hence, also in the third embodiment the light beam B at the output of the microscope 103 is substantially collimated in the xz plane while is focused in the yz plane, meaning that the light beam B is focused in a single line L lying in the xy plane and parallel to the direction x. The line L is placed at a distance f6 from the objective 6 and has a length equal to Dx provided by the above equation [7] and a width equal to the beam waist Wy provided by the above equation [8]. No spurious lines are formed, since the light beam B at the output of the microscope 103 is substantially collimated in the xz plane, namely its size along the direction x is substantially constant. Since no spurious lines are generated within the sample 10, out-of-focus contributions are negligible and accordingly very clean linear images of the sample 10 are provided.

It shall be noticed that, similarly to the second embodiment, in this third embodiment the position of the cylindrical lens 3 (namely, the value of the distance d36 from the objective 6) affects the collimation of the light beam B on the xz plane at the output of the microscope. Therefore, since a certain degree of collimation is needed at least for preventing possible spurious lines from falling within the thickness of the sample 10, also in this third embodiment the position of the cylindrical lens 3 is subject to much narrower tolerance than in the first embodiment. Further, longitudinal scanning of the sample may not be implemented by moving the cylindrical lens 3 or changing its focal length f3.

This third embodiment is however advantageous in that it comprises a very reduced number of components, and is accordingly very compact.

It shall be noticed that the above equations [3], [5] and [8], which provide the width Wy of the line L emitted by the microscopes 100, 101/102 and 103, respectively, rely on the assumption that the light beam B at the input of the objective 6 is equal to or narrower than the objective pupil. In case the light beam B at the input of the objective 6 is larger than the objective pupil, the equations [3], [5] and [8] no more apply. In particular, the width of the line L obtained in such condition is narrower than the width Wy calculated according to equations [3], [5] and [8].

According to variants not shown in the drawings, in all the microscopes 100, 101 and 102 described above the cylindrical lens 3 may be replaced by a component performing a similar function, such as for instance a SLM (Spatial Light Modulator).

Although the above description is specifically referred to TPEF microscopy, it may be appreciated that the present invention is more generally applicable to multi-photon excited fluorescence microscopy.

1-15. (canceled)

16. A two-photon excited fluorescence microscope comprising:
a laser source configured to emit a light beam; and
an optical arrangement configured to receive the light beam from the laser source and to shape the light beam so that, at an output of the microscope, the light beam is substantially collimated in a first transverse direction perpendicular to a propagation direction of the light beam at the output of the microscope and is focused in a second transverse direction perpendicular to the first transverse direction and to the propagation direction, thereby forming a line parallel to the first transverse direction.

17. The microscope according to claim 16, wherein the optical arrangement comprises a cylindrical lens and an objective.

18. The microscope according to claim 17, wherein the cylindrical lens and the objective are substantially confocal.

19. The microscope according to claim 17, wherein the optical arrangement further comprises a spherical lens interposed between the cylindrical lens and the objective.

20. The microscope according to claim 19, wherein the spherical lens and the objective are substantially confocal.

21. The microscope according to claim 19, wherein the cylindrical lens has a cylindrical surface with an axis contained in a plane parallel to the first transverse direction and the propagation direction.

22. The microscope according to claim 21, wherein a distance between the cylindrical lens and the spherical lens is tunable for tuning a distance between the objective and the line.

23. The microscope according to claim 21, wherein a focal length of the cylindrical lens is tunable for tuning a distance between the objective and the line.

24. The microscope according to claim 21, further comprising a scanning system configured to translate the line along the second transverse direction, the scanning system being positioned at a back-focal plane of the cylindrical lens.

25. The microscope according to claim 19, wherein the optical arrangement comprises a further spherical lens.

26. The microscope according to claim 25, wherein the cylindrical lens and the further spherical lens are substantially confocal, and wherein the further spherical lens and the spherical lens are substantially confocal.

27. The microscope according to claim 20, wherein the cylindrical lens has a cylindrical surface with an axis contained in a plane parallel to the second transverse direction and the propagation direction.

28. The microscope according to claim 25, wherein the further spherical lens is interposed between the cylindrical lens and the spherical lens.

29. The microscope according to claim 25, wherein the cylindrical lens is interposed between the further spherical lens and the spherical lens.

30. The microscope according to claim 29, further comprising a scanning system configured to translate the line along the second transverse direction, the scanning system being positioned at a back-focal plane of the further spherical lens.
